(19) United States
(12) Patent Application Publication
(10) Pub. No.: US 2025/0098631 A1
(43) Pub. Date: Mar. 27, 2025

(54) BIOCHAR AND SWITCHGRASS ANIMAL BEDDING

(71) Applicant: Wakefield Farms LLC, Reedsville, PA (US)

(72) Inventors: Michael A. Zock, Saxonburg, PA (US); Nelson Peachey, Groveport, OH (US)

(21) Appl. No.: 18/899,704

(22) Filed: Sep. 27, 2024

Related U.S. Application Data
(60) Provisional application No. 63/540,867, filed on Sep. 27, 2023.

(51) Int. Cl. A01K 1/015; B65B 27/12

(52) U.S. Cl. CPC A01K 1/0155; B65B 27/125

(57) ABSTRACT

A cost effective, efficient packaged homogenized animal bedding, namely a chicken bedding, includes biochar and switchgrass. The biochar may be a hardwood based biochar such as red oak and may be 1-30 mm particle size. The biochar and switchgrass are sized to minimize dust. The switch grass may be chopped having a size of 1″-6″, preferably 1″-5″. The packaged animal bedding may be compressed within a flexible package. The packaged animal bedding may further include a filler comprising one of grasses, hemp, jute, coir fiber, and wood shavings, specifically fibrillated wood, and combinations thereof.

### RELATED APPLICATIONS

This application claims priority to U.S. provisional patent application Ser. No. 63/540,867 filed Sep. 27, 2023, titled “Biochar and Switchgrass Animal Bedding” which application is incorporated herein by reference in its entirety.

### BACKGROUND INFORMATION

### 1. Field of the Invention

The present invention relates to packaged animal bedding, specifically to a prepackaged biochar and switchgrass animal bedding.

### 2. Background Information

The present invention relates to the field of animal bedding. Animal bedding, in ethology and animal husbandry, is material, usually organic, used by animals to support their bodies when resting or otherwise stationary. It reduces pressure on skin, heat loss, and contamination by waste produced by an animal or those with whom the animal shares living space.

Many animals benefit from animal bedding, including livestock, poultry, rodents and reptiles. Animal bedding, in the simplest context, provides comfort for these animals. When constructed properly, these cushioned structures decrease irritability and rough textures that can cause pain, pressure, and stress on the subject. This also prevents bruising and sores to preserve the physical beauty of the animal. Animal bedding also creates an environment of moisture retention. Although generally incapable to prevent all microbial activity, bedding absorbs a substantial amount of moisture within the animal's living environment. Animal bedding also yields insulation against cold weather and drafts. Animal bedding can also provide odor control and can decrease dust to protect against respiratory infections. Proper animal bedding yields a decrease in stress and pain, encouraging peaceful resting opportunities that in turn increase the overall life, productivity, and well-being of the animal.

Wood shavings, typically pine, cedar, and aspen, have been used as animal bedding and are described as absorbent with good odor control. See Kains, Frank; Lovell, Barbara; Payne, Mike; Tremblay, Rob (1997). “Livestock Bedding Alternatives”. Different textures such as fine cut, soft shreds, or thick cut are used for different animals. Wood shavings have been described as being dusty and containing aromatic oils that can cause respiratory, gastrointestinal, urinary tract, or skin disorders and other health problems in some animals. See Angulo, F. J.; Steinmuller, N.; Demma, L.; Bender, J. B.; Eidson, M. (2006-12-15). “Outbreaks of Enteric Disease Associated with Animal Contact: Not Just a Foodborne Problem Anymore”, Clinical Infectious Diseases. 43 (12): 1596-1602. Aspen and kiln-dried wood shavings have been proposed and described as being to be less dusty, plus the oils are removed.

Hemp animal bedding has been proposed and described as extremely absorbent with good odor control and minimal dust, and superior insulation properties. Additionally, hemp is naturally pest-repellent and horses are not tempted to eat it. Hemp bedding is recommended for horses with allergy or respiratory issues. See “Not Your Grandmother's Bedding: Horse Bedding Alternatives—The Horse”. The Horse. 2016 Dec. 8.

Corncob based animal bedding has been used and, as generally utilized, it contains no aromatic oils or dust. Corncobs used as animal bedding are heat dried improving absorbent properties. However, when water or urine is absorbed, the corncob will start molding quickly so daily cleaning is needed. If not properly maintained, bacterial infections are actually likely to occur with this bedding material. It has also been suggested that corncob animal bedding could be dangerous if ingested by a small animal.

Paper animal bedding includes either recycled paper or cardboard boxes. Paper animal bedding generally contains no oils and little dust. Paper is very absorbent, but when saturated with water or urine, a strong odor results. See Gunderson, Scott; Wise, Gregg; Roach, John; Muench, Dave. “Using Chopped Newspaper for Animal Bedding” Wisconsin County Extension Office.

| Straw is a soft, dry stalk containing small grains such as barley, oats, rice, rye, and wheat. Straw animal bedding is easy to handle and available in most agricultural areas. A straw based animal bedding generally utilizes straw that is not palatable to the animal, namely that the seed is not consumed by the animal in question. Straw has excellent absorbency and is unlikely to mold.

Hay is composed of grasses that have been cut and then dried. Although hay is most commonly used for food, it also can be used for the purpose of animal bedding. This, however, may result in an insufficient diet for the animal if it begins eating its bedding. In addition, old hay may give off the dust that could result in respiratory problems. Additionally, a disadvantage of using hay is that it is one of the more expensive beddings. Further, although it is quite absorbent, once it is soiled, it begins to decompose quickly producing an unpleasant odor. Because of the moisture, hay will mold quickly and could result in a bacterial infection.

Wood chip animal bedding uses a mixture of bark, sawdust, and post peelings. Agriculturalists use wood chips as cost-efficient animal bedding. While its cost may be desirable, woodchips have been described as providing minimal comfort and absorbency. Wood chips generate mold and mildew, because of their highly damp environment. This causes bacterial growth and potential infection if not changed often. Wood chips are also known to stain the coat of animals from bedding in moist chips.

Saw dust animal bedding has been proposed but must be kiln-dried to ensure cleanliness and absorbability. Sawdust ensures quick and easy cleaning for small enclosures, because of the soiled or wet material begins to clump together. Although the cleanup is easier, sawdust is known to create a lot of health problems such as respiratory, urinary tract, mastitis, and skin disorders.

Sand based bedding have been used and are ideal when looking at microbial growth. Sand bedding for some larger animals is a highly comfortable bedding because of its natural ability to form to the animal's curvature. However, large sand particles can cause abrasions and bruise on an animal. Another downfall is sand is not very absorbent and causes a difficult clean-up of soiled materials.

Each of the above has generally been proposed for chicken bedding with varied results. See “The Best (and worst!) Options for Chicken Coop Bedding-Backyard Chicken Project” at the backyardchickenproject.com for a detailed discussion which ranked Cat Litter, Cedar Shavings, Newspaper, Sand and Hay as bad options and Hemp, wood (pine) shavings or wood chips, leaves and grass clippings and straw as good options.

It is clear from the above that providing a cost effective efficient animal bedding can be challenging. It is one object of the present invention to provide a cost effective efficient animal bedding.

### SUMMARY OF THE INVENTION

This invention is directed to a cost effective, efficient packaged homogenized animal bedding, namely a chicken bedding, including biochar and switchgrass. The biochar may be a hardwood based biochar such as red oak. The biochar and switchgrass are sized to minimize dust.

The packaged animal bedding according to the present invention may provide wherein the switch grass is chopped having a size of 1″-6″, preferably 1″-5″. The packaged animal bedding according to the present invention may provide wherein the biochar is formed of hardwood and is 1-30 mm particle size. The packaged animal bedding according to the present invention may provide wherein the bedding is compressed within a flexible package. The packaged animal bedding according to present invention may provide as further including a filler comprising one of grasses, hemp, jute, coir fiber, and wood shavings, specifically fibrillated wood, and combinations thereof.

These and other aspects of the present invention will be clarified in the description of the preferred embodiment of the present invention described below in connection with the attached figures in which like reference numerals represent like elements throughout.

### BRIEF DESCRIPTION OF THE FIGURES

FIGS. 1 and 2 are schematic representations of the homogenizing and packaging of the biochar and switchgrass animal bedding according to the present invention.

### DESCRIPTION OF THE PREFERRED EMBODIMENTS

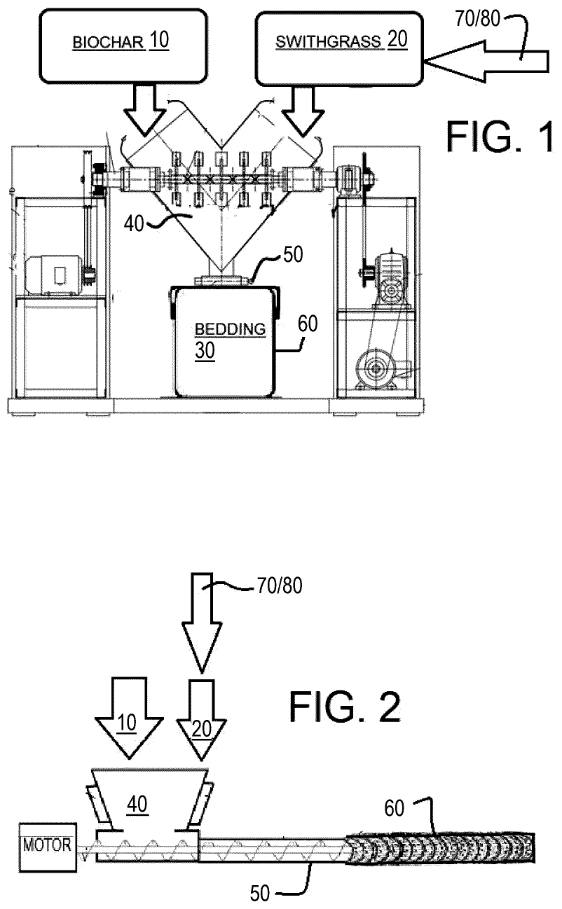

The present invention is directed to a packaged animal bedding 30, particularly to a chicken bedding, including a homogenized mixture 30 of biochar 10 and switchgrass 20. FIGS. 1 and 2 are schematic representations of the homogenizing and packaging of the biochar and switchgrass animal bedding 30 according to the present invention.

### Biochar 10

Biochar 10 is the lightweight black residue, made of carbon and ashes, remaining after the pyrolysis of biomass, and is a form of charcoal. Biochar 10 is defined by the International Biochar Initiative as “the solid material obtained from the thermochemical conversion of biomass in an oxygen-limited environment”. Biochar 10 is a stable solid that is rich in pyrogenic carbon and can endure in soil for thousands of years. Biochar 10 in the present invention specifically is a high-carbon, fine-grained residue that is produced via pyrolysis of hardwoods, such as in particular oaks, specifically red oak. It is the direct thermal decomposition of the hardwood biomass in the absence of oxygen (preventing combustion), which process produces a mixture of solids (the biochar), liquid (bio-oil), and gas (syngas) products. Gasifiers may be effectively used to form the biochar used in the present invention. The gasification process consists of four main stages: oxidation, drying, pyrolysis, and reduction. Temperature during pyrolysis in gasifiers is 250-550° C. (523-823 K), 600-800° C. (873-1,073 K) in the reduction.

The biochar 10 of the present invention is hardwood based. Hardwood is wood from dicot trees. Hardwoods have a more complex structure than softwoods and are often much slower growing as a result. The dominant feature separating “hardwoods” from softwoods is the presence of pores, or vessels. A vessel (also known as vessel element or vessel member or xylem vessel) is one of the cell types found in xylem, the water conducting tissue of plants. The vessels may show considerable variation in size, shape of perforation plates (simple, scalariform, reticulate, foraminate), and structure of cell wall, such as spiral thickenings.

The biochar 10 of the present invention is preferably from oak. An oak is a tree or shrub in the genus of quercus of the beech family, Fagaceae. There are approximately 500 extant species of oaks. The biochar used in the present invention may be effectively formed from red oaks, Subgenus Quercus (the New World clade (or high-latitude clade), mostly native to North America); Section Lobatae (i.e., North American red oaks).

The biochar 10 used in the present invention is sized, via screening, to minimize dust in the animal bedding and 1-30 mm pieces have proven effective preferably 1-15 mm.

### Switchgrass 20

The animal bedding 30 in package 60, particularly a chicken bedding, of the present invention uses switchgrass 20. Switchgrass 20 is a hardy, deep-rooted, perennial rhizomatous grass that begins growth in late spring. It can grow up to 2.7 m (8 ft 10 in) high, but is typically shorter than big bluestem grass or indiangrass. The leaves are 30-90 cm (12-35 in) long, with a prominent midrib. Switchgrass 20 uses C4 carbon fixation, giving it an advantage in conditions of drought and high temperature. Switchgrass is both a perennial and self-seeding crop, which means farmers do not have to plant and reseed after annual harvesting. Once established, a switchgrass stand can survive for ten years or longer. Switchgrass 20 can grow on marginal lands and requires relatively modest levels of chemical fertilizers. Overall, it is considered a resource-efficient, low-input crop now often used for producing bioenergy from farmland. The switchgrass 20 specifically used in the present invention is sized to minimize dust with 1″-6″ nominal lengths being effective, preferably 1″-5″.

### Packaging (Mixer 40 and Bagger 50)

The biochar 10 and switchgrass 20 used in the present invention is brought together in volumetric ratios of 1-1 to 1-20 (biochar 10 to switchgrass 20) and homogenized (mixer 40) prior to packaging (bagger 50) in package 60. The FIG. 1 shows the use of a dual axis mixing or blending unit with internal agitating paddles for mixer 40 from BRIGHTSAIL machinery. The bagger 50 is shown as merely a discharge valve, but the bagger 50 may include a system for weighing the mixture 30 and for sealing the bag 60 to further automate the process. The system shown is a schematic representation of one possible packaging system.

Alternatively, a rotary blending drum or a mixing/blending auger 40 can be utilized to homogenize the biochar and switchgrass prior to packaging, typically in flexible bag type containers 60 as shown in FIG. 2.

Alternatively, any of the mixer and bagging unit may act to compress the bedding 30 in the container 60. For example a compressed bale forming bagging machine forming a plastic sheet covered compressed bale having a rectangular configuration, which may be efficiently inserted into a cardboard box (not shown) for shipping. The bedding 30 within the container 60 is preferably of sufficiently lightweight for shipping such as less than 35 lbs., preferably about 30 lbs.

### Additives and Fillers

Additives 70 may be added as desired for particular purposes, such as reactivated carbon for odor control and absorption. As noted above many materials have been proposed and the present invention allows such additives to be easily incorporated within the bedding 30 of the invention. However, expense is a key component of animal bedding 30, and no additives 70 is preferred. A well balanced or designed animal bedding 30 that merely sits on the shelf due to the expense is of very little practical good in the industry. For this reason, additives 70, if any are expected to be less than 5% of the total volume of the bedding 30, preferably less than 2%, and optionally not present at all.

Fillers 80 may optionally be added as desired for particular purposes, namely to enhance the characteristics of the bedding 30. Fillers 80 are generally considered to be bulk additions and may be added in volumetric ratios of 5-40% total fillers to amount of Switchgrass 10. The biochar 10 and switchgrass 20 used in the present invention with fillers is brought together in volumetric ratios of 1-1 to 1-20 (biochar 10 to the combination of switchgrass 20 and fillers). Fillers 80 for the present invention include grasses, hemp, jute, coir fiber, and wood shavings, specifically fibrillated wood, and combinations thereof. All the filler 80 particles will have general size ranges comparable to the switchgrass 20 discussed above. The fillers 80 may be premixed with the switch grass 20 or more likely simply added together into the mixer 40

When natural fibers are exposed to a shearing force, the fibers undergo partial delamination of the cell wall and the fiber becomes fibrillated. This manifests itself in the creation of a highly branched or hairy appearance of the fiber, which leads to an increase in relative bonded area with improved mechanical properties. One filler 80 that is believed to have advantageous properties for animal bedding is fibrillated wood filler 80 with each such particle being about ½″ to 4″ in length.

It is apparent that many variations to the present invention may be made without departing from the spirit and scope of the invention. The present invention is defined by the appended claims and equivalents thereto.

What is claimed is:

1. A packaged animal bedding including a homogenized mixture of biochar and switchgrass.

2. The packaged animal bedding according to claim 1 wherein the switch grass is chopped.

3. The packaged animal bedding according to claim 1 wherein the switch grass is chopped having a size of 1″-5″.

4. The packaged animal bedding according to claim 3 wherein the biochar is formed of hardwood.

5. The packaged animal bedding according to claim 4 wherein the biochar is 1-30 mm particle size.

6. The packaged animal bedding according to claim 5 wherein the bedding is compressed within a flexible package.

7. The packaged animal bedding according to claim 5 further including a filler comprising one of grasses, hemp, jute, coir fiber, and wood shavings, specifically fibrillated wood, and combinations thereof.

8. A packaged chicken bedding including a homogenized mixture of biochar and switchgrass.

9. The packaged chicken bedding according to claim 8 wherein the switch grass is chopped.

10. The packaged chicken bedding according to claim 8 wherein the switch grass is chopped having a size of 1″-6″.

11. The packaged chicken bedding according to claim 10 wherein the biochar is formed of hardwood.

12. The packaged chicken bedding according to claim 11 wherein the biochar is 1-30 mm particle size.

13. The packaged chicken bedding according to claim 12 wherein the bedding is compressed within a flexible package.

14. The packaged chicken bedding according to claim 13 further including a filler comprising one of grasses, hemp, jute, coir fiber, and wood shavings, specifically fibrillated wood, and combinations thereof.

15. Method of forming packaged animal bedding comprising the steps of:
Homogenizing a mixture of biochar and switchgrass; and
Placing the homogenized mixture of biochar and switchgrass in a flexible package.

16. The method of forming packaged animal bedding according to claim 15 wherein the switch grass is chopped prior to the homogenizing step.

17. The method of forming packaged animal bedding according to claim 15 wherein the switch grass is chopped having a size of 1″-6″ prior to the homogenizing step.

18. The method of forming packaged animal bedding according to claim 17 wherein the biochar is formed of hardwood.

19. The method of forming packaged animal bedding according to claim 18 wherein the biochar is 1-30 mm particle size.

20. The method of forming packaged animal bedding according to claim 19 wherein the bedding is compressed within a flexible package.
